(19) United States
(12) Patent Application Publication
(10) Pub. No.: US 2003/0071710 A1
(43) Pub. Date: Apr. 17, 2003

(54) Safety switch

(76) Inventor: Tsung-Mou Yu, Taipei (TW)

Correspondence Address: SUPREME PATENT SERVICES, POST OFFICE BOX 2339, SARATOGA, CA, 95070, US

(21) Appl. No.: 09/977,589

(22) Filed: Oct. 13, 2001

(51) Int. Cl. H01H 71/16; H01H 71/58

(52) U.S. Cl. 337/66; 337/68; 337/72

(57) ABSTRACT

A safety switch includes a casing having a first terminal plate having a first contact point and a second terminal plate to which an end of a bimetal plate is connected. A second contact point is connected to a tongue of the bimetal plate. A switch member is connected to the casing and a connection member is connected to an end of the switch member. An end of the connection member has a recess and an end of the bimetal plate is movably located in the recess.

### FIELD OF THE INVENTION

The present invention relates to a safety switch that allows a bimetal plate movably engaged with a gap defined in a switch member so that even if the switch member is stocked and the current is override, the circuit can be opened.

### BACKGROUND OF THE INVENTION

A conventional see-saw switch is shown in FIG. 1 and includes a switch member 11 having a protrusion 110 which movably presses a plate 12 so that two contacts on two ends of the plate 12 can be respectively pushed to contact a corresponding contact point. This type of switch cannot automatically jump off when override. FIGS. 2A and 2B show a switch disclosed in U.S. Pat. No. 5,262,748 and includes a switch member 13 which has one end connected to a connection plate 14 which is connected to a bimetal plate 170. A curve resilient plate 18 has one end connected to the casing 10 of the switch device and the other end of the resilient plate 18 connected to the bimetal plate 170. Three terminal plates 15, 16, 17 are connected to the casing 10 of the switch device and the connection plate 170 has the other end thereof connected to the terminal plate 17. A contact point 171 is connected on the connection plate 170 and another contact point 160 is connected to the terminal plate 16. The connection plate 170 is lowered by pushing the switch member 13 to close the circuit. When override, the bimetal plate 170 is deformed and separates the two contact points 171, 160. However, if the switch member 13 is stocked or if the resilient plate 18 is failed, the bimetal plate 170 will not be deformed. Besides, if the deformation force of the bimetal plate 170 is larger than the force of the resilient plate 18, the resilient plate 18 will keep the bimetal plate 170 at an open status. If the users push the switch member 13 again, the bimetal plate 170 will jump off again, and this could result in sparks and has potential danger.

FIGS. 3A and 3B show a Taiwanese published patent No. 334165 and includes a switch 20 has a driving member 21 which is slidably engaged with a connection member 22. A spring 24 is connected between the driving member 21 and an inside of the casing of the switch device. A bimetal plate 23 has one end thereof fixed to one of two terminal plates of the casing and the other end of the bimetal plate 23 is engaged with the connection plate 22. The bimetal plate 23 contacts the other terminal plate when the switch member 20 is pushed. When current overrides, the bimetal plate 23 is deformed and pushes the driving member 21 to let a convex portion of the driving member 21 engage with a recess 25 defined in an inside of the casing, and the bimetal plate 23 is separated from the terminal plate. When either one of the switch member 20, the driving member 21 or the connection member 22 is out of order or stocked, the circuit cannot be opened. If the spring force of the spring 24 is too large, then the bimetal plate 23 cannot jump off from the terminal plate, and if the spring force of the spring 24 is too small, then the bimetal plate 23 could jump off often.

FIGS. 4A, 4B and 4C show a switch device disclosed in U.S. Pat. No. 5,760,672 and includes a switch member 28 which has one end connected to a connection plate 26 which has a hook portion for receiving an end of a bimetal plate 27. Three terminal plates are connected to the casing of the switch device and a contact point 271 on the bimetal plate 27 is to contact another contact point 272 on one of the terminal plates. A gap ΔS is defined in the hook portion so as to allow the bimetal plate 27 to be deformed. However, this type of switch can only used with specific type of see-saw switch member. Besides, the connection member 26 extends through a hole in the bimetal plate 27 so that when either one of the horizontal parts 261, 262 of the hook portion of the bimetal plate 27 is stocked or jammed by the hole in the bimetal plate 27, the bimetal plate 27 could not jump off. When the temperature drops, the deformed bimetal plate 27 will contact the contact point 272 again. Because the override situation is not released, the circuit will be opened and closed repeatedly.

### SUMMARY OF THE INVENTION

In accordance with one aspect of the present invention, there is provided a safety switch which comprises a casing having a first terminal plate and a second terminal plate. A first contact point is connected to the first terminal plate and a bimetal plate is fixedly connected to the second terminal plate. A second contact point is connected to a tongue of the bimetal plate. A switch member is pivotally connected to the casing and a connection member is movably engaged with an end of the switch member and has a recess defined therein. The other end of the bimetal plate is movably located in the recess.

The primary object of the present invention is to provide a safety switch device wherein the bimetal plate is allowed to be deformed to cut off the circuit even if the switch member is stocked.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a see-saw type switch device;

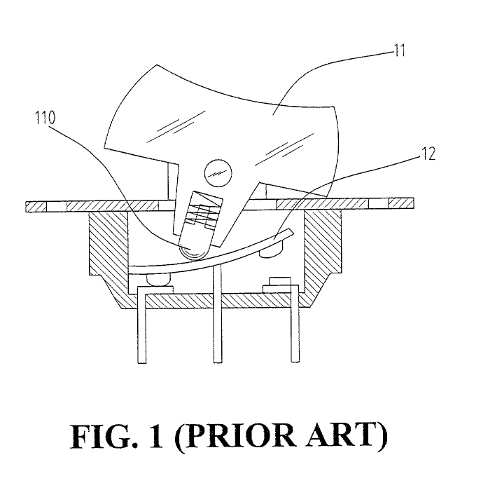

FIGS. 2A and 2B show the open status and the close status of a switch device disclosed in U.S. Pat. No. 5,262,748;

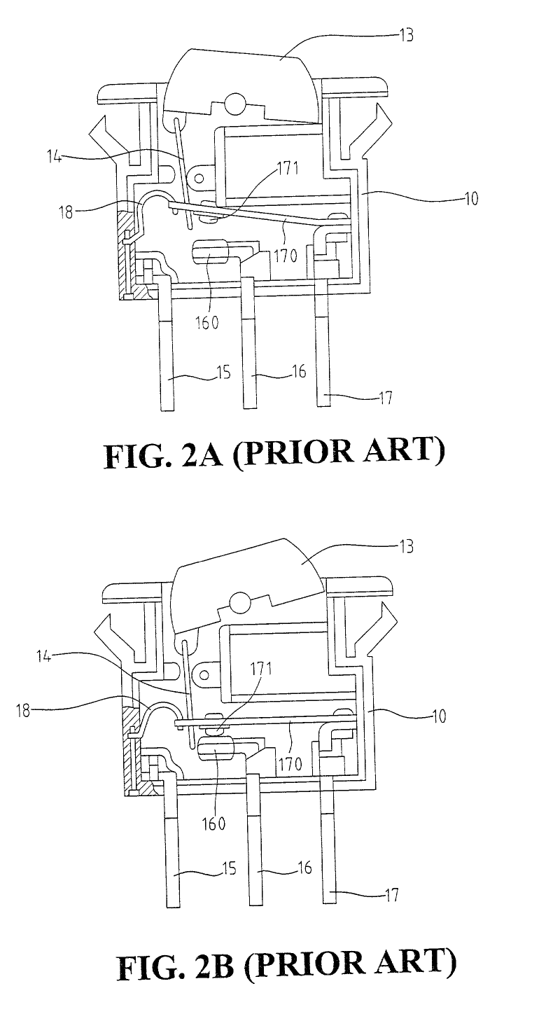

FIGS. 3A and 3B show the open status and the close status of a switch device disclosed in Taiwanese published patent No. 334165;

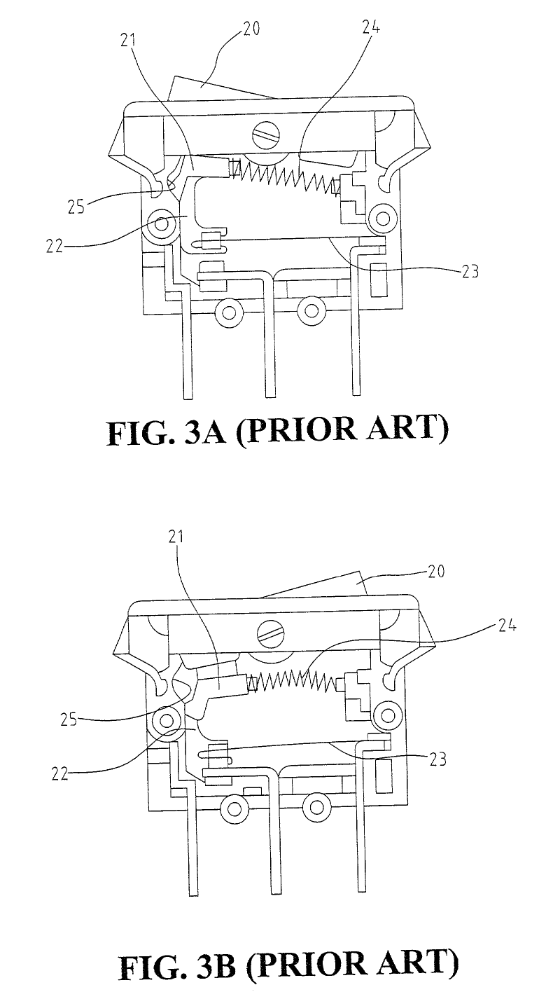

FIGS. 4A, 4B and 4C show the open status and the close status of a switch device disclosed in U.S. Pat. No. 5,760,672;

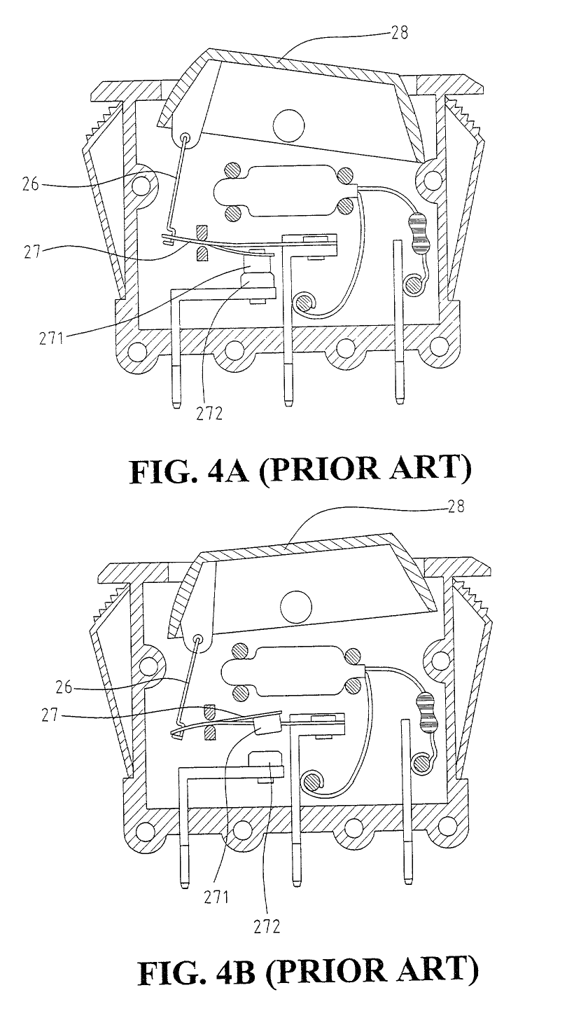

FIG. 5 is an exploded view to show a safety switch device of the present invention;

FIG. 6 is a cross sectional view to show an OFF status of the safety switch device of the present invention;

FIG. 7 is a cross sectional view to show an ON status of the safety switch device of the present invention;

FIG. 8 is a cross sectional view to show that the tongue of the bimetal plate is deformed when the current overrides and the protrusion of the bimetal plate is moved within the recess of the connection plate;

FIG. 9A shows the bimetal plate used in the safety switch device of the present invention;

FIG. 9B shows two legs of the bimetal plate used in the safety switch device of the present invention is pushed toward each other, and

FIGS. 10A and 10B show that the tongue of the bimetal plate used in the safety switch device of the present invention is deformed in two different directions.

### DETAILED DESCRIPTION OF THE INVENTION

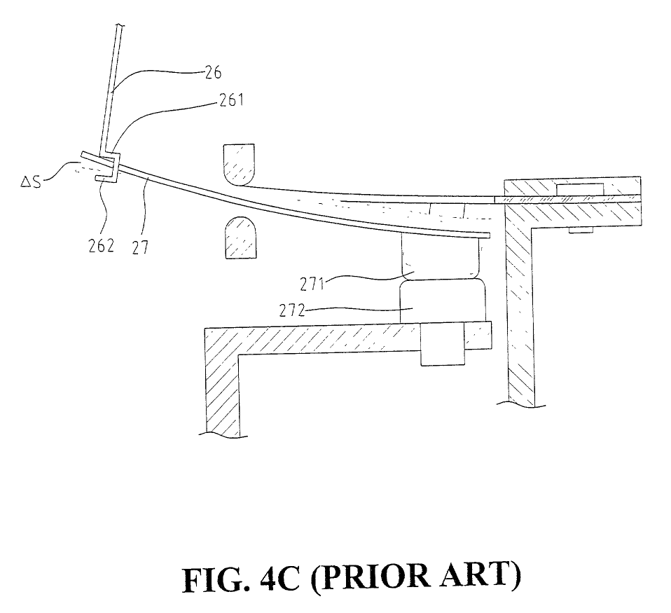

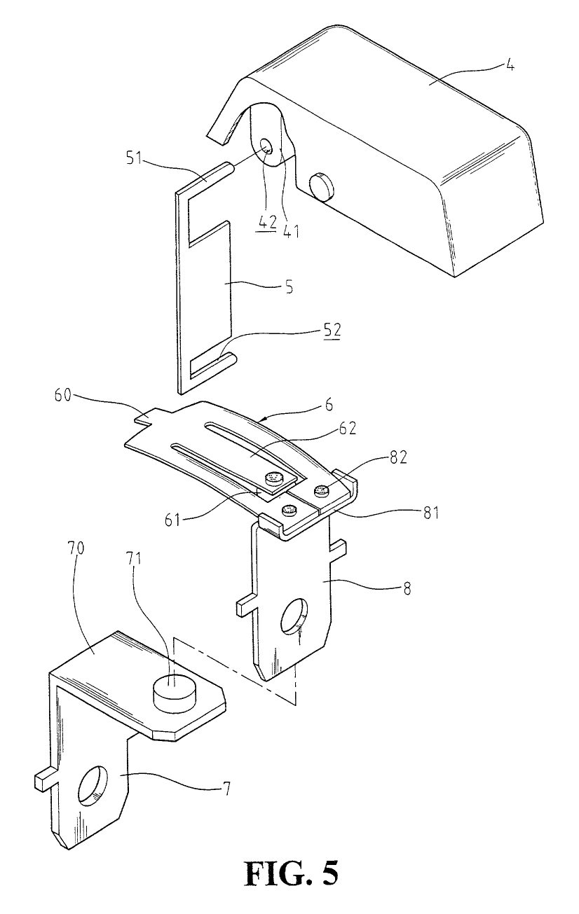

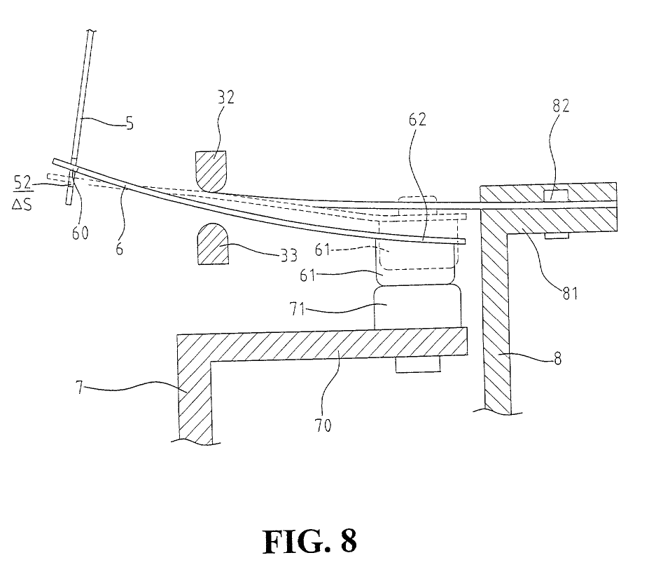

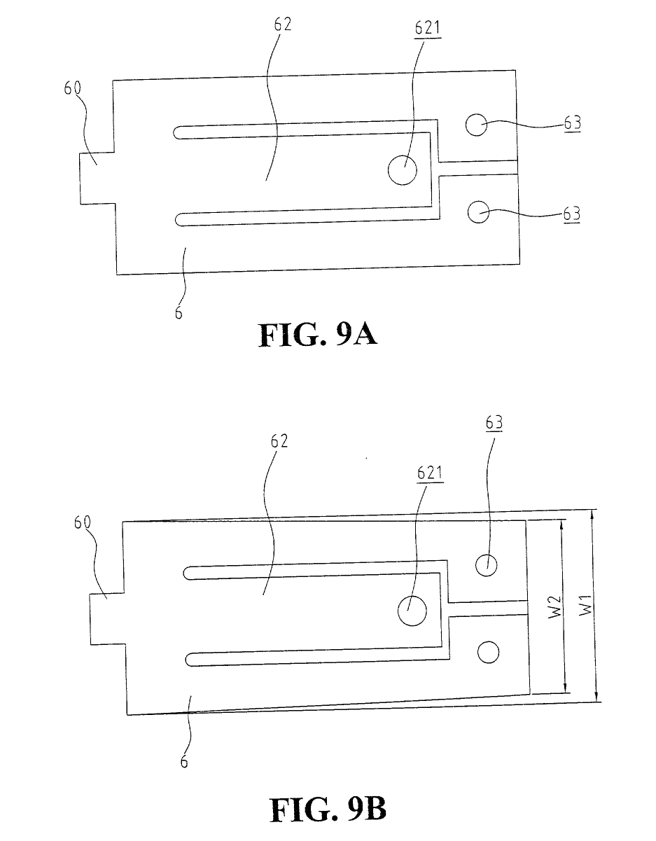

Referring to FIGS. 5 and 6, the safety switch device of the present invention comprises a casing 3 which has three slots 31 defined in an end thereof for a first terminal plate 7 and a second terminal plate 8 respectively engaged with two of the slots 31. A first contact point 71 is connected to a horizontal portion 70 on the first terminal plate 7. Further referring to FIG. 9A, a bimetal plate 6 has an end fixedly connected to a horizontal portion 81 on the second terminal plate 8. The bimetal plate 6 is a U-shaped member and a tongue 62 extends from the U-shaped portion of the bimetal plate 6 and is located between two legs of the bimetal plate 6. A second contact point 61 is engaged with a hole 621 in the free end of the tongue 62 of the bimetal plate 6. The two legs of the bimetal plate 6 each have a hole 63 and when mounting the two holes 63 in two legs of the bimetal plate 6 are to be mounted to the bosses 82 on the horizontal portion 81 of the second terminal plate 8, the two legs are first pushed toward each other to narrow the width therebetween from W1 to W2 as shown in FIG. 9B. The narrower W2 allows the two holes 63 in two legs of the bimetal plate 6 to be mounted to the bosses 82. A protrusion 60 extends from the U-shaped portion of the bimetal plate 6 and located opposite to the tongue 62. Two ribs 32, 33 respectively extend from an inside of the casing 3 and the bimetal plate 6 extends between the two ribs 32, 33. The two ribs 32, 33 prevent the bimetal plate 6 from being over-deformed.

A switch member 4 is pivotally connected to a top hole 30 defined in the casing 3 and a lug 41 extends from an underside of an end of the switch member 4. A connection member 5 has one end 51 engaged with a hole 42 defined in the lug 41, and the other end of the connection member 5 has a recess 52. The protrusion 60 of the bimetal plate 6 is movably located in the recess 52. When the left end of the switch member 4 is pushed, the protrusion 60 is pushed by an inside of the recess 52 so that the tongue 62 is raised away from the first contact point 71 to cut off the circuit as shown in FIG. 6.

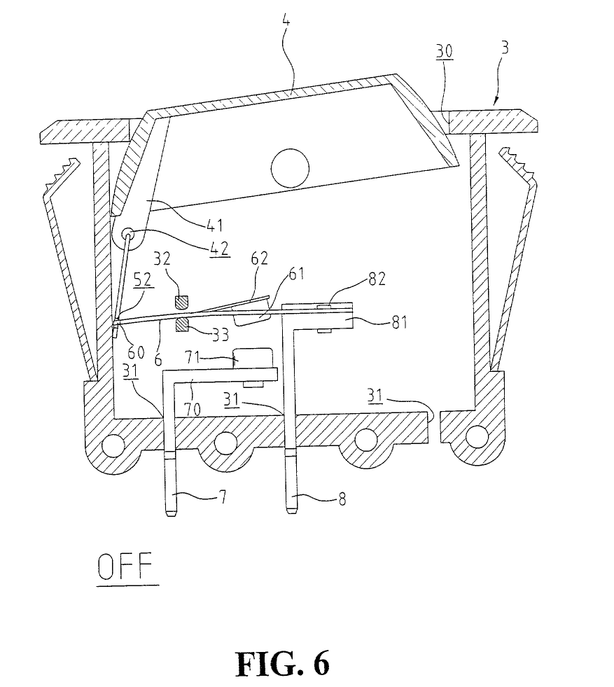

As shown in FIG. 7, when the right end of the switch member 4 is pushed, the protrusion 60 is lifted by the inside of the recess 52 and the second contact point 61 is lowered to contact the first contact point 71 to connect the circuit.

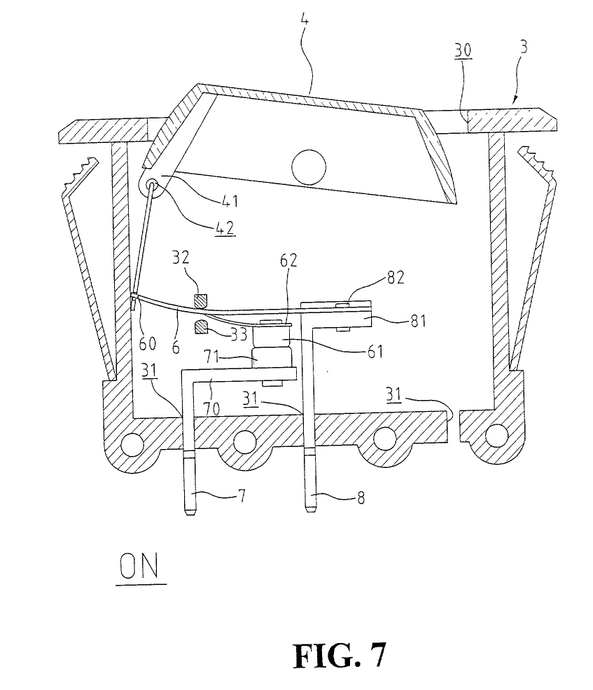

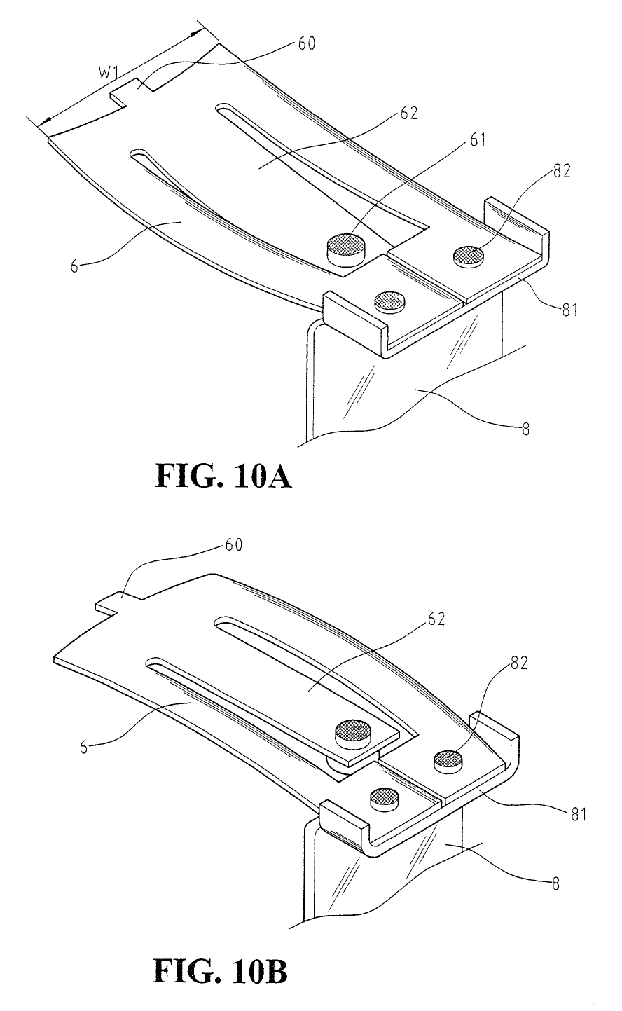

Referring to FIGS. 8, 10A and 10B, when the current overrides and the switch member 4 or the connection member 5 is jammed or stocked and cannot be pivoted, the width ΔS of the recess 52 is width enough to allow the protrusion 60 to move therein, and the tongue 62 is deformed upward from the position as shown in FIG. 10A to the position as shown in FIG. 10B to cut off the circuit.

While we have shown and described the embodiment in accordance with the present invention, it should be clear to those skilled in the art that further embodiments may be made without departing from the scope of the present invention.

What is claimed is:

1. A safety switch comprising:
a casing having a first terminal plate and a second terminal plate respectively engaged therewith a first contact point connected to said first terminal plate and a bimetal plate having an end fixedly connected to said second terminal plate, a second contact point connected to said bimetal plate, a switch member pivotally connected to said casing, and
a connection member movably engaged with an end of said switch member and having a recess defined therein and the other end of said bimetal plate movably located in said recess.

2. The safety switch as claimed in claim 1, further comprising two ribs respectively extending from an inside of said casing and said bimetal plate extending between said two ribs.

3. The safety switch as claimed in claim 1, wherein said bimetal plate is a U-shaped member and includes two legs and a tongue extends from said U-shaped member and located between said two legs, said second contact point located on a free end of said tongue, said two legs of said bimetal plate each having a hole which is mounted to two bosses on said second terminal plate.
